(19) United States
(12) Patent Application Publication
(10) Pub. No.: US 2021/0004782 A1
(43) Pub. Date: Jan. 7, 2021

(54) ALLOCATION METHOD AND DEVICE FOR DIVIDING THE SUM OF A BANK TRANSACTION BETWEEN A PLURALITY OF USERS

(71) Applicant: ORANGE, Paris (FR)

(72) Inventors: François Toutain, Chatillon Cedex (FR); Emmanuel Le Huerou, Chatillon Cedex (FR); Béatrice Foucault, Chatillon Cedex (FR)

(21) Appl. No.: 16/971,427

(22) PCT Filed: Feb. 4, 2019
(86) PCT No.: PCT/FR2019/050246

§ 371 Date: Aug. 20, 2020

(30) Foreign Application Priority Data
Feb. 23, 2018 (FR) 1851583

(51) Int. Cl. G06Q 20/32; G06Q 20/22; G06Q 20/40

(52) U.S. Cl. CPC G06Q 20/3223; G06Q 20/40; G06Q 20/29

(57) ABSTRACT

An allocation method and device for automatically dividing the sum of a first bank transaction between a first and at least a second user. The method includes defining, through a share identifier, a common sharing space for sharing between the first and second users. The common space includes identifiers of users taking part in the share and at least one bank transaction allocation rule. The division is made by obtaining the first bank transaction from a bank account of the first user, which is associated with a division request and with a share identifier. The device associates the obtained transaction with the common sharing space corresponding to the share identifier, and sends a request to the second user for authorization to divide. When an authorization is obtained, the device orders a second bank transaction between the bank accounts of the first and second users according to the allocation rule.

### CROSS-REFERENCE TO RELATED APPLICATIONS

This application is a Section 371 National Stage Application of International Application No. PCT/FR2019/050246, filed Feb. 4, 2019, which is incorporated by reference in its entirety and published as WO 2019/162589 A2 on Aug. 29, 2019, not in English.

### TECHNICAL FIELD

The invention lies in the field of banking applications and relates in particular to a method for automatically dividing the sum of a banking transaction between a plurality of users having a communication terminal.

### PRIOR ART

When it comes to dividing expenses within a household, users of banking services generally opt for a joint account. A joint account is a bank account associated with several holders. The joint holders are jointly responsible for the account and may commit all of the funds contained therein. A joint account is more often than not used by couples, since it makes it easier to manage household expenses. The joint holders make payments into the joint account from their personal account and have payment means associated with the joint account. In this way, expenses can be divided between the joint holders. However, the joint account has the drawback that a holder is jointly responsible for the debts incurred by the joint holder.

Using a joint account requires particular vigilance because a single joint holder may commit all of the funds credited to the joint account. Moreover, when making a purchase, a joint holder has to have a payment means associated with the joint account that is separate from the payment means that he has for his personal account, such as for example a second credit card or a second checkbook. Moreover, when the account balance does not allow a particular purchase to be made, the joint holders must make a payment prior to the purchase in order to avoid an overdraft.

Another technique for dividing expenses among several users of banking services is also known. This technique consists in providing users who wish to share expenses with a payment means configured so as to debit the sum of a purchase from two separate accounts in accordance with a division rule established beforehand. A user may thus be provided with a payment card associated with two separate bank accounts. When a purchase is made using such a card, one part of the sum of the purchase is debited from a first account and a second part of the sum from a second account, in accordance with the division rule established by the joint contracting parties to the service. Such a service requires a great deal of trust between the joint contracting parties because a user has no control over the purchases made by the other user and may have his personal account debited for a purchase to which he does not wish to contribute.

There is thus a need for a technique that makes it possible to easily divide an expense between several users without a user however systematically being jointly responsible for the expenses incurred by the other user, and without increasing the number of payment means.

### SUMMARY OF THE INVENTION

To this end, what is proposed is a method for automatically dividing the sum of a first banking transaction between a first and at least one second user, the method comprising the following steps:
defining, through a sharing identifier, a common sharing space between the first user and at least the second user, comprising the identifiers of the users who are the subject of the sharing and at least one banking transaction division rule;
obtaining the first banking transaction recorded in a bank account of said first user, the banking transaction being associated with a division request and with a sharing identifier,
associating the obtained first banking transaction with the common sharing space corresponding to the sharing identifier,
sending a division authorization request at least to the second user in accordance with the division rule associated with the common sharing space and, when division authorization is obtained:
ordering a second banking transaction between a bank account of the at least one second user and the bank account of the first user in accordance with a division sum obtained using the division rule of the common sharing space.

A user is thus able to select a banking transaction from a personal account so that it is shared with one or more other users between whom he wishes to divide the sum thereof. As a variant, the division may relate to only part of the sum of a transaction.

The proposed solution comprises setting up a space shared between at least a first and a second user who are respectively holders of a first and of a second bank account. The shared space corresponds for example to one or more databases able to be accessed by the first and second users. The shared space is configured so as to store banking transactions associated beforehand with a division request made by the first and/or second users. The shared space may also correspond to a sharing identifier associated beforehand with at least two users; the identifier then being associated with shared banking transactions.

Such a shared space may be accessible through a communication terminal designed to obtain and display a plurality of shared transactions. The first and second users may thus access, from a smartphone for example, transactions associated with this space by one or the other of the users. Transactions associated with one and the same shared space may be downloaded and aggregated by a server or terminal from one or more databases and be displayed by a terminal in the form of a list grouping together a plurality of transactions associated beforehand with a division request.

The transactions to be divided may be selected through the express designation of a transaction by a user, for example through a suitable graphical interface on a terminal. For example, a communication terminal may display a list of transactions associated with a user's bank account via a web page or a suitable software application, and offer, through suitable user interface elements, such as buttons, the option of selecting a particular transaction in order to associate it with a particular shared space.

Thus, according to another aspect, on the terminal of a first user, what is proposed is a method for requesting automatic division of the sum of a first banking transaction between a first and at least one second user, the method comprising the following steps:
defining, through a sharing identifier, a common sharing space between the first user and at least the second user, comprising the identifiers of the users who are the subject of the sharing and at least one banking transaction division rule;
selecting a request to divide the first banking transaction recorded in a bank account of said first user, from a list of banking transactions that is displayed on a graphical interface of a terminal of the first user;
associating the first banking transaction with the defined sharing identifier;
sending this association to a division server in order to make a division authorization request to the at least one second user in accordance with the division rule associated with the common sharing space, and ordering a banking transaction between a bank account of the at least one second user and the bank account of the first user in accordance with a division sum obtained using the division rule of the common sharing space.

According to yet another aspect, on the terminal of a second user, what is proposed is a method for validating a request to automatically divide the sum of a first banking transaction between a first and at least one second user, the method comprising the following steps:
defining, through a sharing identifier, a common sharing space between the first user and at least the second user, comprising the identifiers of the users who are the subject of the sharing and at least one banking transaction division rule;
displaying, on a graphical interface of a terminal of the second user, a request to divide the sum of the first banking transaction associated with the defined sharing identifier and a division sum obtained using the division rule associated with the common sharing space corresponding to the sharing identifier;
displaying a button for selecting division authorization on the graphical interface; and, following selection of the authorization to divide the displayed first banking transaction:
sending the division authorization to the division server in order to implement an order for a second banking transaction between a bank account of the second user and the bank account of the first user in accordance with the obtained division sum.

The division may thus take place only when the division authorization has been obtained by the users of the common sharing space.

The division rule may be set beforehand by the first and second users of the shared space. For example, the users may agree on a division rule whereby each user is responsible for 50% of the expense. By applying such a division rule, it is proposed to automatically calculate the sum of one or more bank transfers in order to divide one or more credit or debit transactions that are shared between the users of the shared space.

It is understood that not only transactions relating to expenses but also transactions relating to incomes may be selected and added to the shared space in order to be divided. In this way, a first user may share some of his income with a second user in accordance with an allocation rule that may, in one particular embodiment, be separate from an expense division rule. For example, a payment of family allowances received by one of the spouses in a household may be shared with the other spouse.

According to one particular embodiment, the method is such that the division rule is determined based on the sum of at least one credit transaction in a bank account of the first user and on a sum of at least one credit transaction in a bank account of the second user.

The division rule may thus be calculated automatically based on analysis of the history of the transactions of the respective personal accounts of the first and second users. In particular, the division rule may be determined based on a cumulative total of credit transactions in the respective accounts of the users. For example, an analysis of the history of the transactions in the respective accounts of the users may determine that the salary received by the second user is double the salary received by the first user. The division rule may then be determined according to an identical ratio, such that the expenses are shared equitably according to the users' income.

According to one particular embodiment, the method is such that the division rule is validated beforehand by the first and the at least one second user.

A user of the shared space thus has the guarantee that his bank account will not be debited without his authorization. A user may thus explicitly validate the division ratio and be assured that this ratio will not be modified without his knowledge. A user is therefore not able to unilaterally decide on the division rule.

According to one particular embodiment, the method is such that the obtained banking transaction is selected beforehand in accordance with at least one feature of the transaction.

The selection is for example made automatically according to a reference of a debtor or a creditor associated with the transaction. Transactions corresponding to purchases made in a particular store that is configured beforehand may thus be automatically selected and recorded in the shared space. For example, transactions corresponding to purchases in a supermarket identified in a description of the transaction are automatically added to the shared space, whether they are performed by one or the other of the users of the shared space. The selection may be made in accordance with other criteria such as geolocation data, a business or administrative name, a sum, a date or even a time range.

According to one particular embodiment, the method is such that the obtained banking transaction is selected beforehand according to a feature of a payment means used to perform the transaction.

A transaction may be automatically selected to be added to a particular sharing space depending on the payment means that is used. For example, the transactions performed by way of a particular payment card are automatically selected and added to a shared space, no additional user action being required, the selection being made in accordance with an identifier of the payment card. As a variant, a transaction may be automatically selected to be added to a particular sharing space on the basis of a particular secret code associated with a payment means. Thus, one and the same payment card may have two separate secret codes, the use of a particular code causing the transaction to be selected.

According to one particular embodiment, the method is such that credit transactions are associated with a first division rule, debit transactions being associated with a second division rule separate from the first division rule.

The expenses and incomes shared by a user may thus be divided in different proportions depending on whether this involves sharing a credit or a debit. The method thus makes it possible to set up a more equitable division of banking transactions.

According to one particular embodiment, the method is such that it furthermore comprises a step of sending a notification to a user when the difference between the transfers made and the transfers remaining due in accordance with the division rule exceeds a threshold over a given period.

In this way, the users of the shared space are notified by a reminder when a cumulative sum of transactions for which a division request is made exceeds a threshold. The method thus relieves users from having to be constantly vigilant and avoids them having to frequently consult the transactions recorded in the shared space. Thus, when the cumulative total of shared expenses over a period deviates excessively from the division rule, the users may take measures to rebalance their respective contribution to the financing of purchases made by other users of the shared space.

According to one particular embodiment, the method is such that a notification is sent to a user following the detection of a particular transaction in a bank account associated with the first or with the second user.

The overdue division transaction reminder is performed at a convenient time, for example after a user has received a salary. In this way, the users of a shared space are notified at the most convenient time to reimburse shared expenses, for example following the payment of a salary.

According to one particular embodiment, an association is stored between the reimbursement transfer and a particular transaction.

It is thus possible to identify, in a user's personal account, a shared transaction and a bank transfer made in order to divide the transaction. The user is thus able to clearly see, on his account statement, the reimbursement transaction corresponding to a particular expense that is shared for the purpose of being divided.

The invention also relates, in a manner corresponding to the division method, to a device for automatically dividing the sum of a first banking transaction between a first and at least one second user, the device being characterized in that it comprises:
definition means for defining, through a sharing identifier, a common sharing space between the first user and at least the second user, comprising the identifiers of the users who are the subject of the sharing and at least one banking transaction division rule;
obtainment means for obtaining the first banking transaction recorded in a bank account of said first user, the banking transaction being associated with a division request and with a sharing identifier,
association means for associating the obtained first banking transaction with the common sharing space corresponding to the sharing identifier,
sending means for sending a division authorization request at least to the second user in accordance with the division rule associated with the common sharing space;
ordering means for ordering a second banking transaction between a bank account of the at least one second user and the bank account of the first user in accordance with a division sum obtained using the division rule of the common sharing space, implemented when division authorization is obtained.

According to another aspect, what is proposed is an automatic division server comprising a division device as described above.

According to yet another aspect, what is proposed is an automatic division terminal comprising a division device.

According to one embodiment, what is proposed is a terminal of a first user comprising, in order to implement a request to automatically divide the sum of a first banking transaction between a first and at least a second user:
definition means for defining, through a sharing identifier, a common sharing space between the first user and at least the second user, comprising the identifiers of the users who are the subject of the sharing and at least one banking transaction division rule;
a graphical interface displaying a list of banking transactions and comprising a selection means for selecting a request to divide the first banking transaction recorded in a bank account of said first user in the displayed list;
association means for associating the first banking transaction with the defined sharing identifier;
communication means for sending this association to a division server in order to make a division authorization request to the at least one second user in accordance with the division rule associated with the common sharing space, and ordering means for ordering a banking transaction between a bank account of the at least one second user and the bank account of the first user in accordance with a division sum obtained using the division rule of the common sharing space.

What is also proposed is a terminal of a second user comprising, in order to implement validation of a request to automatically divide the sum of a first banking transaction between a first and at least one second user:
definition means for defining, through a sharing identifier, a common sharing space between the first user and at least the second user, comprising the identifiers of the users who are the subject of the sharing and at least one banking transaction division rule;
a graphical interface displaying a request to divide the sum of the first banking transaction associated with the defined sharing identifier and a division sum obtained using the division rule associated with the common sharing space corresponding to the sharing identifier;
the graphical interface displaying a button for selecting division authorization; and
communication means for sending the division authorization to the division server in order to implement an order for a second banking transaction between a bank account of the second user and the bank account of the first user in accordance with the obtained division sum implemented following the selection of the division authorization for the displayed first banking transaction.

In one particular embodiment, the various steps of the method according to the invention are determined by computer program instructions.

As a result, the invention also targets a computer program comprising instructions for executing the steps of the division method when said program is executed by a processor.

Such a program may use any programming language, and be in the form of source code, object code, or of intermediate code between source code and object code, such as in a partially compiled form, or in any other desirable form.

The invention relates lastly to an information medium able to be read by a processor and on which there is recorded a computer program comprising instructions for executing the steps of the division method.

The information medium may be any entity or device capable of storing the program. For example, the medium may include a storage means, such as a ROM, for example a CD-ROM or a microelectronic circuit ROM, or else a magnetic recording means, for example a floppy disk or a hard disk. Moreover, the information medium may be a transmissible medium such as an electrical or optical signal, which may be routed via an electrical or optical cable, by radio or by other means. The program according to the invention may in particular be downloaded from an Internet network. As an alternative, the information medium may be an integrated circuit in which the program is incorporated, the circuit being designed to execute or to be used in the execution of the method in question.

The various abovementioned embodiments or implementation features may be added, independently or in combination with one another, to the steps of the division methods such as defined above.

The servers, terminals, devices, programs and information media have at least advantages similar to those conferred by the method to which they correspond.

### BRIEF DESCRIPTION OF THE FIGURES

Other features and advantages of the invention will become more clearly apparent from reading the following description of one particular embodiment, given by way of simple illustrative and non-limiting example, and the appended drawings, in which:

FIG. 1 shows a network architecture suitable for implementing the division method, according to one particular embodiment,

FIG. 2 illustrates the main steps of the division method in one particular embodiment of the method,

FIG. 3a shows a first terminal on which there is displayed a list of banking transactions associated with a personal bank account of a first user,

FIG. 4a shows a second terminal on which there is displayed a list of banking transactions associated with a personal bank account of a second user,

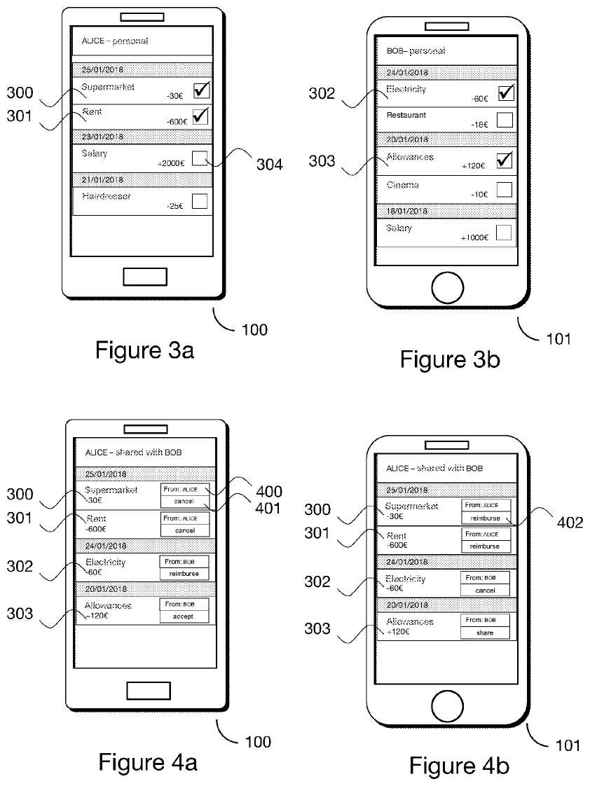

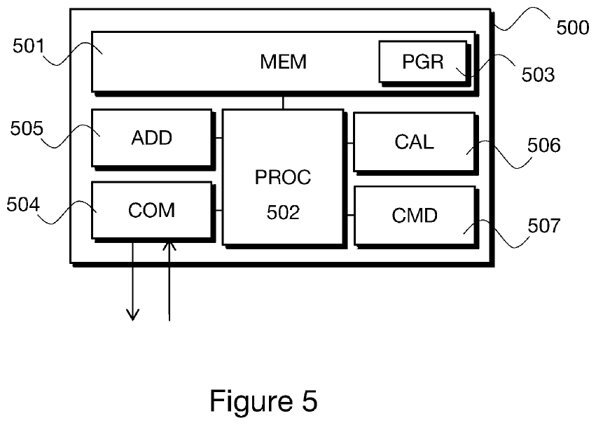

FIG. 3b illustrates, according to one particular embodiment, the first terminal displaying a shared space according to the invention comprising transactions originating from personal user accounts shown in FIGS. 3a and 4a,

FIG. 4b illustrates, according to one particular embodiment, the second terminal displaying a shared space according to the invention comprising transactions originating from personal user accounts shown in FIGS. 3a and 4a,

FIG. 5 shows the architecture of a division device according to one particular embodiment.

### DETAILED DESCRIPTION

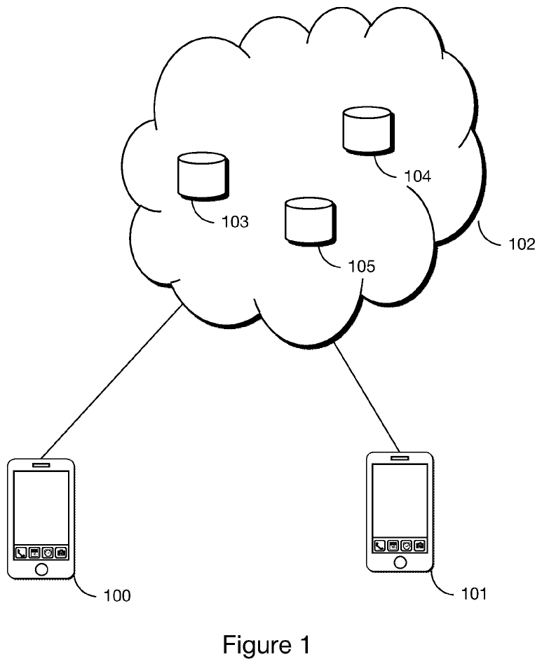

FIG. 1 shows a network architecture suitable for implementing the division method, according to one particular embodiment. FIG. 1 in particular shows a first terminal 100 and a second terminal 101 that are connected to a communication network 102. For example, the terminals 100 and 101 are smartphones connected to the Internet 102 via 2G, 3G, 4G or Wi-Fi access networks that are not shown in the figure. To this end, the terminals have a radio communication interface compatible with wireless access technology of the access network. The terminals 100 and 101 furthermore have a processing unit and a memory. Computer program instructions designed to be executed by a processor of the processing unit may be loaded into the memory. The terminals also have a display such as a screen and a command input unit such as a touchscreen or a keypad. In this way, the terminals 100 and 101 are able to download and execute computer programs from the network 102, and in particular programs comprising instructions configured so as to implement the division method according to one particular embodiment.

The network 102 comprises servers 103, 104 and 105. These servers are for example database servers that comprise at least a network interface, a processing unit and a memory suitable for storing instructions which can be executed by a processor of the processing unit. The memories of the servers 103, 104 and 105 comprise for example instructions configured so as to receive requests from the terminals 100 and 101, execute processing operations in accordance with the received commands and transmit the results of these processing operations to the terminals 100 and 101 or to other equipment or between them.

The server 103 is for example a banking server hosting banking services for the user of the terminal 100.

It may be a Web server to which the terminal 100 is able to connect in order to obtain for example a statement of transactions recorded in a bank account of the user of the terminal 100.

The server 104 is for example a second banking server hosting banking services for the user of the terminal 101. It may be a Web server to which the terminal 101 is able to connect in order to obtain for example a statement of transactions recorded in a bank account of the user of the terminal 101.

Various implementations of such an architecture are possible, it being possible for the servers 103 and 104 to be separate or to correspond to just one and the same server.

The server 105 comprises a memory into which instructions are loaded in order to execute the steps of the division method according to one particular embodiment.

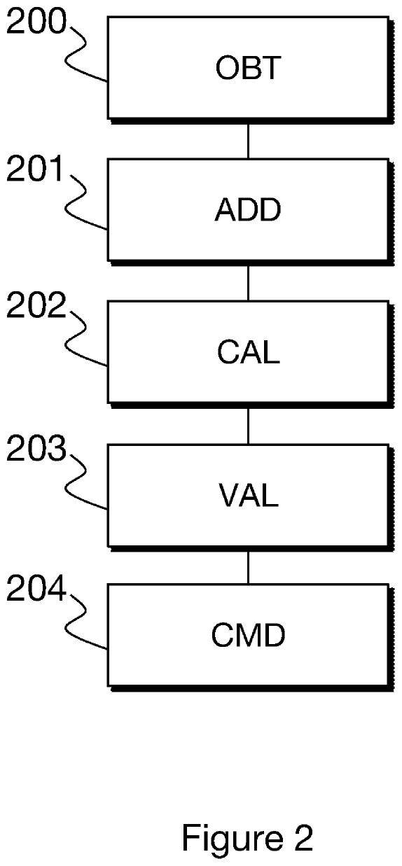

One particular embodiment of the division method will now be described with reference to FIG. 2.

In a first step 200, the server 105 obtains banking transactions recorded in one or more personal bank accounts of the users of the terminals 100 and 101. For example, the server receives data corresponding to the transactions 300 and 301 recorded in a personal account of the user of the terminal 100 and shown in FIG. 3a, and data corresponding to the transactions 302 and 303 recorded in a personal account of the user of the terminal 101 and shown in FIG. 3b. These transactions 300, 301, 302 and 303 were selected beforehand by the respective users of the terminals 100 and 101 and associated with a request for division between the users of the terminals 100 and 101. The data representative of the transactions that were the subject of a division request by the users are received by the server by way of a network interface that allows the server to exchange data with bank servers 103 and 104.

Thus, the transactions 300 and 301 were the subject of a division request by the user of the terminal 100 and the transactions 302 and 303 were the subject of a division request by the user of the terminal 101. When a transaction is the subject of a division request, for example when the user of the terminal 100 selects the transaction 300 displayed on the screen of the terminal using a checkbox 304, the transaction, that is to say its features and/or an identifier that allows the server to access the features of the transaction, are transmitted to the server 105.

In this way, the server 105 obtains banking transactions recorded in bank accounts of the users of the terminals 100 and 101 that were previously associated with a division request by the users.

According to one particular embodiment, a transaction is automatically associated with a division request when at least one feature of the transaction corresponds to a predetermined criterion. Non-exhaustively, the criterion may be one or more criteria from among a business name of an establishment with which the transaction was performed, a geographical location associated with the transaction, a date or a time range.

According to one particular embodiment, a transaction is automatically associated with a division request when it is performed with a particular payment means. For example, the user of the terminal 100 may have a payment card configured such that banking transactions corresponding to purchases made by way of said card are automatically associated with a division request. A transaction performed via a particular checkbook or a particular contactless payment means may in the same way trigger association of the transaction with a division request.

To this end, transactions corresponding to a predetermined criterion as described above, or performed by a particular payment means, are enriched with an indication according to which the transaction should be divided. The indication may comprise a sharing identifier so that various transactions may be associated with various sharing spaces by the server 105. The server 105 may for example comprise a database in which a table associates identifiers of banking transactions selected by the user of the terminal 100 with sharing space identifiers. Likewise, the server 105 may for example comprise a database in which a table associates identifiers of banking transactions selected by the user of the terminal 101 with sharing space identifiers. As a variant, another server such as the server 105 may store such tables.

In the step 201, the server 105 associates the transactions obtained in the step 200 with a sharing space associated with the users of the terminals 100 and 101. The sharing space corresponds for example to a record in one or more databases comprising a sharing identifier associated with users, such as for example with the users of the terminals 100 and 101. The server 105 thus comprises a database in which there are recorded one or more sharing spaces between various groups of users. The records may also be stored in a manner divided into separate databases, such as for example in the databases of the servers 103 and 104.

When the server 105 associates transactions with a particular sharing space, it becomes possible for them to be consulted by the users associated with this sharing space. According to one particular embodiment, associating a transaction with a sharing space comprises storing at least one feature of the transaction with a particular sharing identifier. The server 105 may thus formulate a list of transactions shared by the users of the terminals 100 and 101 and transmit this list to the terminals 100 and 101. Such a list is shown for example in FIGS. 4a and 4b and comprises both transactions selected by the user of the terminal 100 and those selected by the user of the terminal 101.

The users of the terminals 100 and 101 may access one or more shared spaces with which they are associated from the terminals 100 and 101. To this end, a terminal transmits a request to the server 105 comprising at least one sharing identifier that makes it possible to unambiguously identify a sharing space and a user identifier, and in return obtains a list of the transactions shared in this space. The transactions are displayed on a terminal in the form of a list of shared transactions with which there are associated interaction elements 400, 401, 402 that allow a user to trigger actions relating to this transaction.

For example, a debit transaction 300 associated with a sharing space may appear, when the user of the terminal 100 consults the shared space, in association with an identifier 400 of the user at the origin of the transaction, and a cancel button 401 for canceling this sharing. Said user may thus reverse his decision to share an expense. When the user of the terminal 101 accesses the same sharing space, this same transaction 300 appears in association with a button 402 for reimbursing the user of the terminal 100 for some of his expense.

Thus, the transactions associated with the sharing space are displayed in a differentiated manner depending on the user at the origin of the transaction and depending on the user of the terminal on which the sharing space is consulted.

In a step 202, the server 105 calculates the sum of a transaction for dividing the sum of a shared transaction. The sum of the division transaction is calculated in accordance with a division rule. The division rule defines how the sum of a transaction should be divided between the various users of a shared space.

For example, the division rule may define sharing of the sum of the transactions recorded in the sharing space according to which the sum of a transaction is divided into as many shares as there are users associated with the sharing space. The division rule may of course establish that a sum will be shared in proportions that are decided arbitrarily by the users of the sharing space. For example, the users of the terminals 100 and 101 may have an interface on their terminal that makes it possible to configure a division rule in accordance with particular proportions.

According to one particular embodiment, when a user defines a division rule from his terminal, this rule takes effect only after having been validated by the other users of the space. The rule may be validated through an exchange of messages between the terminals 100 and 101, via the server 105. For example, when the user modifies the division rule from the terminal 100, a message comprising a request to validate the modification is sent to the terminal 101, the rule taking effect only when the terminal 101 validates the rule through a response message.

According to one particular embodiment of the method, the division rule is automatically determined based on the sum of at least one credit transaction in a bank account of the first user and on a sum of at least one credit transaction in a bank account of the second user. The division rule is then established such that the sum of the shared transactions is divided between the users of the shared space in proportions corresponding to the users' incomes. For example, on the account statement of FIG. 3a, it is possible to see a credit transaction corresponding to the payment of a salary of €2000 and, on the account statement of FIG. 3b, it is possible to see a credit transaction corresponding to the payment of a salary of €1000. The ratio between the salary received by the user of the terminal 100 and that received by the user of the terminal 101 is therefore two thirds for the terminal 100 and one third for the terminal 101. The division rule may then be automatically defined in accordance with the same proportion. The method thus allows an equitable division of expenses in accordance with the resources of the various users of the shared space, without the users being involved.

According to one particular embodiment, credit transactions are associated with a first division rule, debit transactions being associated with a second division rule separate from the first division rule. Two division rules are thus associated with the sharing space, a first rule being associated with credit transactions, another rule separate from the first rule being associated with debit transactions. The server 105 determines the division rule to be applied to a given transaction on the basis of an indication relating to the type of transaction. Such an indication may be obtained with the transaction data obtained in the step 200.

In the step 203, the server 105 obtains division authorization. Such authorization is obtained for example by receiving a message from a terminal whose user is associated with the shared space. The authorization is triggered by the user of the terminal via an interaction element associated with a particular transaction displayed in the shared space. For example, the user of the terminal 101 may trigger the sending of a message comprising authorization to divide the sum of the transaction 300 by pressing the button 402 associated with the transaction 300 shown in FIG. 4b.

When the server 105 receives division authorization, a bank transfer corresponding to the sum calculated in accordance with the division rule is ordered by the server 105 in a step 204. The bank transfer order may take the form of a message transmitted to a banking services server comprising a reference of an account to be debited, a reference of an account to be credited and the sum of the transfer.

According to one particular embodiment, the transfer order furthermore comprises an identifier of a banking transaction. For example, when the user presses the button 402 in order to trigger a reimbursement transaction in accordance with the division rule in force in the shared space, a transfer order to the user of the terminal 100 is transmitted. The division rule determines the sum owed by the user of the terminal 101 to the user of the terminal 100. For example, if the division rule is determined automatically in accordance with the incomes of the users of the terminals 100 and 101, a reimbursement of €10 is owed by the user of the terminal 101 to the user of the terminal 100 when he authorizes the division of the sum of the transaction 300 by pressing the button 402. Specifically, as the salary received by the user of the terminal 101 represents one third of the cumulative income of the users of the shared space, the shared expenses are divided in the same proportion. A transfer of €10 is thus ordered from a personal account of the user of the terminal 101 to a personal account of the user of the terminal 100.

The transfer order also comprises the identifier of the transaction 300 to which the reimbursement corresponds. In this way, it is possible, on a personal account statement of the user of the terminal 100, to match the reimbursement bank transfer to the transaction that gave rise to the reimbursement. The user is then able to precisely follow the expenses that have given rise to a reimbursement from the other users of the shared space.

In this way, it is possible to store an association between a reimbursement transfer and the transaction associated with a corresponding division request.

According to one particular embodiment, the method may comprise an optional step in which a shared transaction for which a transfer has been ordered in the step 204 is associated with an indication according to which a reimbursement has been made. To this end, the server 105 may modify a record in a database storing the shared transactions by indicating a “reimbursed” status for the transaction. In this way, the display of the list of shared transactions on a terminal may comprise visual information according to which the division request can no longer be canceled. Such information may also be displayed in a personal user account in connection with a transaction for which a division request was made and gave rise to a reimbursement transfer.

According to one particular embodiment, a special division rule may be associated with a particular transaction. Such a rule is special in that it is associated with a particular transaction. To this end, when a user selects a transaction in order to associate it with a division request, he also selects a division rule to be applied to said transaction. This rule may be different from other rules associated with the shared space. Such a provision makes it possible for example to take into account, in the shared space, a reimbursement transfer made directly by a user. The sum of the transfer may thus be taken into account in order to calculate a balance in the shared space without however giving rise to a division in accordance with the division rule defined for this shared space.

According to one particular embodiment, the method furthermore comprises a step of sending a notification to a user when the difference between the transfers made and the transfers not made and remaining due in accordance with the division rule exceeds a threshold over a given period. To this end, the server 105 queries a database comprising the records of the transactions added to a given shared space. The query is for example an SQL query configured so as to obtain transactions relating to a given period. In this way, the server 105 is able to obtain a list of transactions performed on a particular date, over a period of a week, a month or over any other period of time. The server 105 then calculates, for each user associated with the shared space and for a given period, a cumulative total of the expenses incurred by the user minus the sum of the transfers made to reimburse these expenses, and if applicable minus any shared income. In this way, the server 105 is able to establish a ratio corresponding to the share of the expenses incurred by each user to the total of the expenses. For example, the user of the terminal 100 in FIG. 3a has shared transactions whose cumulative sum amounts to €630 and has not received any reimbursement. The user of the terminal 101 in FIG. 3b, for his part, has shared transactions whose cumulative sum amounts to €60. Thus, for total expenses equal to 600+30+60=€690, the user of the terminal 100 contributed 91.3% while the user of the terminal 101 only contributed 8.7%. If a division rule defines, for this shared space, that the expenses should be divided equally between the two users, then the sum of the reimbursements made to the user of the terminal 100 should be equal to half the expenses incurred over the period under consideration minus the expenses incurred by the user of the terminal 101, that is to say (630−60)/2=€285. Thus, the difference between transfers made and transfers due in accordance with the division rule is €285 for the month of January. If a threshold is configured for example at €200, the server 105 sends a notification to one or more users associated with the shared space.

According to one particular embodiment, such a notification is transmitted following the detection of a particular transaction in a bank account associated with one of the users of the shared space. For example, the notification may be transmitted following the payment of a salary into the account of the user of the terminal 100. The server 105 may detect the payment of a salary into a personal account of a user by regularly accessing, for example once a day, the transaction statement of the account in question in order to detect a transaction therein by comparing descriptions of recorded transactions with a predefined description or by comparing the sum of the transactions with a predefined threshold.

According to one particular embodiment, it is proposed to calculate and display a balance when a user consults the shared space. The balance is calculated for a given period starting from one or more selected transactions recorded in the shared space by the users of the space and takes into account the sum of the transactions shared by one and the other of the users, the reimbursements made and the division rule in order to determine the sum owed by one of the users to the other user. When incomes are shared, the calculation of the balance takes into account the incomes actually shared and the income division rule when this is separate from the expense division rule.

Of course, the invention is not limited to dividing transactions between two users, but may very well apply to sharing between a group of users consisting of more than two people.

FIG. 5 shows the architecture of a device 500 designed to implement the division method according to one particular embodiment.

The device comprises a storage space 501, for example a memory MEM, and a processing unit 502 equipped for example with a processor PROC. The processing unit may be controlled by a program 503, for example a computer program PGR, implementing the division method as described above with reference to FIG. 2, and in particular the steps of obtaining a banking transaction recorded in a bank account of said first user, the banking transaction being associated beforehand with a division request, of adding the at least one obtained transaction to a space shared between the first and the at least one second user, of calculating a sum of a second banking transaction in accordance with the division rule and the sum of the at least one first added banking transaction and, when division authorization is obtained, of ordering a bank transfer in accordance with the sum of the second transaction from the first bank account to a second bank account.

On initialization, the instructions of the computer program 503 are for example loaded into a RAM memory (random access memory), before being executed by the processor of the processing unit 502. The processor of the processing unit 502 implements the steps of the division method in accordance with the instructions of the computer program 503.

To this end, the device furthermore comprises obtainment means (504) for obtaining a banking transaction recorded in a bank account of said first user, the banking transaction being associated beforehand with a division request. The obtainment means correspond for example to a network interface COM designed to receive data from other devices. In particular, the network interface COM allows the device 500 to receive messages from the terminals 100 and 101 and from the servers 103 and 104, such as for example messages comprising data characteristic of a banking transaction associated beforehand with a division request. The obtainment means may be implemented by computer program instructions stored in a memory of the device, such as for example in the memory MEM. The instructions are configured so as to control a network interface COM through the processor PROC in order to receive a message comprising a banking transaction, a reference to a banking transaction or features of a banking transaction transmitted by another device through the communication network 102.

The device 500 also comprises association means 505 for associating the at least one obtained transaction with a space shared between the first and the at least one second user. These addition means 505 are for example implemented by computer program instructions stored in a memory of the device, such as for example in the memory MEM, and designed to be executed by the processor PROC of the processing unit 502. Such instructions are configured so as to record, in a database, an association between the obtained banking transaction and a shared space identifier, for example by way of an SQL (Structured Query Language) query designed to insert a record in a table.

The device 500 furthermore comprises calculation means 506 for calculating a sum of a second banking transaction in accordance with a division rule and the sum of one or more banking transactions obtained by the device and added to the shared space. The calculation means are for example implemented by a computer CAL designed to perform mathematical calculations based on a division rule and on the sum of one or more transactions in the shared space. The computer CAL obtains a division rule associated with the shared space to which the transaction to be divided is added. This rule may be stored in a database of the device in association with an identifier of the shared space, or for example in the memory MEM of the device. According to one particular embodiment, the computer CAL is configured so as to perform calculations based on a division rule selected according to whether the transaction to be divided is a credit or debit transaction.

According to one particular embodiment, the device 500 also comprises ordering means for ordering a bank transfer 507 in accordance with the sum calculated by the computer CAL. These ordering means are implemented when division authorization is obtained. Such authorization is for example obtained by way of the communication module COM. The transfer order means 507 are thus implemented upon receiving a message comprising an indication according to which a debit is authorized by the user of a terminal. The transfer order means 507 may be implemented by computer program instructions stored in a memory of the device, such as for example in the memory MEM, and designed to be executed by the processor PROC of the processing unit 502. The instructions are configured so as to generate a message comprising indications designed to trigger a bank transfer from a personal account of one user of the shared space to a bank account of another user of the shared space. The instructions are furthermore configured so as to cause the message to be sent to a banking service processing server through the network interface COM of the device 500.

According to one particular embodiment, the division method is implemented by a server such as the server 105 shown in FIG. 1. According to another particular embodiment, the division method is implemented by a communication terminal, such as the terminal 100 and/or the terminal 101.

Although the present disclosure has been described with reference to one or more examples, workers skilled in the art will recognize that changes may be made in form and detail without departing from the scope of the disclosure and/or the appended claims.

1. A method for automatically dividing a sum of a first banking transaction between a first and at least one second user, the method being implemented by a device and comprising:
defining, through a sharing identifier, a common sharing space between the first user and at least the second user, the common sharing space comprising identifiers of the first and at least the second users who are subject of the sharing and at least one banking transaction division rule;
obtaining the first banking transaction recorded in a bank account of said first user, the banking transaction being associated with a division request and with a sharing identifier;
associating the obtained first banking transaction with the common sharing space corresponding to the sharing identifier;
sending a division authorization request at least to the second user in accordance with the division rule associated with the common sharing space;
obtaining a division authorization; and
in response to obtaining the requested division authorization, ordering a second banking transaction between a bank account of the at least one second user and the bank account of the first user in accordance with a division sum obtained using the division rule of the common sharing space.

2. The method as claimed in claim 1, wherein the division rule is determined based on a sum of at least one credit transaction in a bank account of the first user and on a sum of at least one credit transaction in a bank account of the second user.

3. The method as claimed in claim 1, wherein the division rule is validated by the first and the at least one second user prior to sending the division authorization request.

4. The method as claimed in claim 1, wherein the obtained first banking transaction is selected before obtaining the first banking transaction in accordance with at least one feature of said first banking transaction.

5. The method as claimed in claim 1, wherein the obtained first banking transaction is selected before obtaining the first banking transaction in accordance with a payment means used to perform the transaction.

6. The method as claimed in claim 1, wherein credit transactions are associated with a first division rule, and debit transactions are associated with a second division rule separate from the first division rule.

7. A method for requesting automatic division of a sum of a first banking transaction between a first and at least one second user, the method being implemented by a device and comprising:
defining, through a sharing identifier, a common sharing space between the first user and at least the second user, the common sharing space comprising identifiers of the first user and at least the second user who are the subject of the sharing and at least one banking transaction division rule;
selecting a request to divide the first banking transaction recorded in a bank account of said first user, from a list of banking transactions that is displayed on a graphical interface of a terminal of the first user;
associating the first banking transaction with the defined sharing identifier;
sending this association to a division server in order to make a division authorization request to the at least one second user in accordance with the division rule associated with the common sharing space; and
ordering a banking transaction between a bank account of the at least one second user and the bank account of the first user in accordance with a division sum obtained using the division rule of the common sharing space.

8. A method for validating a request to automatically divide the sum of a first banking transaction between a first and at least one second user, the method being performed by a terminal of at least the second user and comprising:
defining, through a sharing identifier, a common sharing space between the first user and at least the second user, the common sharing space comprising identifiers of the first user and at least the second user who are the subject of the sharing and at least one banking transaction division rule;
displaying, on a graphical interface of the terminal of at least the second user, a request to divide the sum of the first banking transaction associated with the defined sharing identifier and a division sum obtained using the division rule associated with the common sharing space corresponding to the sharing identifier; and
displaying a button for selecting division authorization on the graphical interface; and,
following selection of the authorization to divide the displayed first banking transaction:
sending the division authorization to the division server in order to implement an order for a second banking transaction between a bank account of the second user and the bank account of the first user in accordance with the obtained division sum.

9. A device for automatically dividing the sum of a first banking transaction between a first and at least one second user, wherein the device comprises:
a processor; and
a non-transitory computer-readable medium comprising instructions stored thereon, which when executed by the processor configure the device to:
define, through a sharing identifier, a common sharing space between the first user and at least the second user, the common sharing space comprising the identifiers of the first user and at least the second user who are the subject of the sharing and at least one banking transaction division rule;
obtain the first banking transaction recorded in a bank account of said first user, the banking transaction being associated with a division request and with a sharing identifier;
associate the obtained first banking transaction with the common sharing space corresponding to the sharing identifier;
send a division authorization request at least to the second user in accordance with the division rule associated with the common shared space; and
order a second banking transaction between a bank account of the at least one second user and the bank account of the first user in accordance with a division sum obtained using the division rule of the common sharing space, implemented in response to obtaining the requested division authorization.

10. The device according to claim 9, wherein the device is comprised in an automatic division server.

11. The device according to claim 9, wherein the device is comprised in a terminal.

12. (canceled)

13. A terminal of a first user, which comprises, in order to implement a request to automatically divide a sum of a first banking transaction between the first user and at least one second user:
a processor; and
a non-transitory computer-readable medium comprising instructions stored thereon, which when executed by the processor configure the terminal of the first user to:
define, through a sharing identifier, a common sharing space between the first user and at least the second user, the common sharing space comprising identifiers of the first user and at least the second user who are the subject of the sharing and at least one banking transaction division rule;
display on a graphical interface a list of banking transactions and a selectable element for selecting a request to divide the first banking transaction recorded in a bank account of said first user in the displayed list;
associate the first banking transaction with the defined sharing identifier;
send this association to a division server in order to make a division authorization request to the at least one second user in accordance with the division rule associated with the common sharing space; and
order a banking transaction between a bank account of the at least one second user and the bank account of the first user in accordance with a division sum obtained using the division rule of the common sharing space.

14. A terminal of a second user, which comprises, in order to implement validation of a request to automatically divide a sum of a first banking transaction between a first and at least the second user:
a processor; and
a non-transitory computer-readable medium comprising instructions stored thereon, which when executed by the processor configure the terminal of the second user to:
define, through a sharing identifier, a common sharing space between the first user and at least the second user, the common sharing space comprising identifiers of the first user and at least the second user who are the subject of the sharing and at least one banking transaction division rule;
display on a graphical interface a request to divide the sum of the first banking transaction associated with the defined sharing identifier and a division sum obtained using the division rule associated with the common shared space corresponding to the sharing identifier;
display on the graphical interface a button for selecting division authorization; and
send the division authorization to the division server in order to implement an order for a second banking transaction between a bank account of the second user and the bank account of the first user in accordance with the obtained division sum implemented following the selection of the division authorization for the displayed first banking transaction.
